(19) United States
(12) Patent Application Publication
(10) Pub. No.: US 2013/0311147 A1
(43) Pub. Date: Nov. 21, 2013

(54) DRILLING OPTIMIZATION

(71) Applicant: Jeremy Alexander Greenwood, Houston, TX (US)

(72) Inventor: Jeremy Alexander Greenwood, Houston, TX (US)

(73) Assignee: Halliburton Energy Services, Inc., Houston, TX (US)

(21) Appl. No.: 13/982,469

(22) PCT Filed: Jan. 31, 2012
(86) PCT No.: PCT/US12/23343

§ 371 Date: Jul. 29, 2013

Related U.S. Application Data
(60) Provisional application No. 61/438,589, filed on Feb. 1, 2011.

(51) Int. Cl. G06F 17/50

(52) U.S. Cl. CPC G06F 17/50
USPC 703/1

(57) ABSTRACT

In accordance with aspects of the present invention, a method well design is presented. The method of well design can include identifying a plurality of task workflows related to a well design; identifying links between individual tasks in the plurality of task workflows; and performing tasks in the plurality of task workflows in order to optimize the well design according to optimization criteria.

### RELATED APPLICATIONS

This application claims priority to U.S. Provisional Application No. 61/438,589, filed on Feb. 1, 2011, which is herein incorporated by reference in its entirety.

### TECHNICAL FIELD

The present invention relates to optimization of the drilling environment through integrated planning performed by multiple technical disciplines.

### DISCUSSION OF RELATED ART

Many parameters are considered when planning or drilling a well. These parameters involve many technical disciplines, for example, well trajectory, wellbore integrity, drilling fluids, drill bit design, Bottom Hole Assembly design, drillstring design, and hydraulics design. Currently, each of those areas is considered independently by different specialists to arrive at a drilling solution. However, factors that affect the operation of one of the many areas may also affect other areas of the well drilling and well construction process. Therefore, the current methods utilized to plan and drill a well are not optimized.

Therefore, there is a need to develop better methods of optimizing the well drilling process as a whole.

### SUMMARY

In accordance with aspects of the present invention, a method of optimizing the well drilling process is enclosed. A method of creating the well drilling design according to some embodiments of the present invention includes identifying a plurality of task workflows related to a well drilling design; identifying links between individual tasks in the plurality of task workflows; and performing tasks in the plurality of task workflows in order to optimize the well design according to an optimization criteria. The plurality of task workflows for the drilling design can be chosen from a set of task workflows that includes Well Trajectory, Wellbore Integrity Analysis, Drilling Fluids Design, Drill Bit and Hole Opener Design, Bottom Hole Assembly Design, Drillstring Design, and Hydraulics Management.

These and other embodiments are further discussed below with respect to the following figures.

### BRIEF DESCRIPTION OF THE DRAWINGS

FIG. 1 illustrates diagrammatically the well construction performance optimization according to some embodiments of the present invention.

FIG. 2 illustrates an optimization scheme according to some embodiments of the present invention.

FIG. 3 illustrates a well drilling planning scheme and shows interconnections according to some embodiments of the present invention.

FIG. 4 illustrates drilling optimization across separate technology areas according to some embodiments of the present invention.

FIG. 5 illustrates a particular example of optimizing drilling fluids design while considering parameters from other technology designs.

FIG. 6 illustrates a particular example of optimizing the well trajectory design while considering parameters from other technology designs.

FIG. 7 illustrates an optimization system according to some embodiments of the present invention.

In the figures, elements that have the same designation have the same or similar functions.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other material that, although not specifically described here, is within the scope and the spirit of this disclosure.

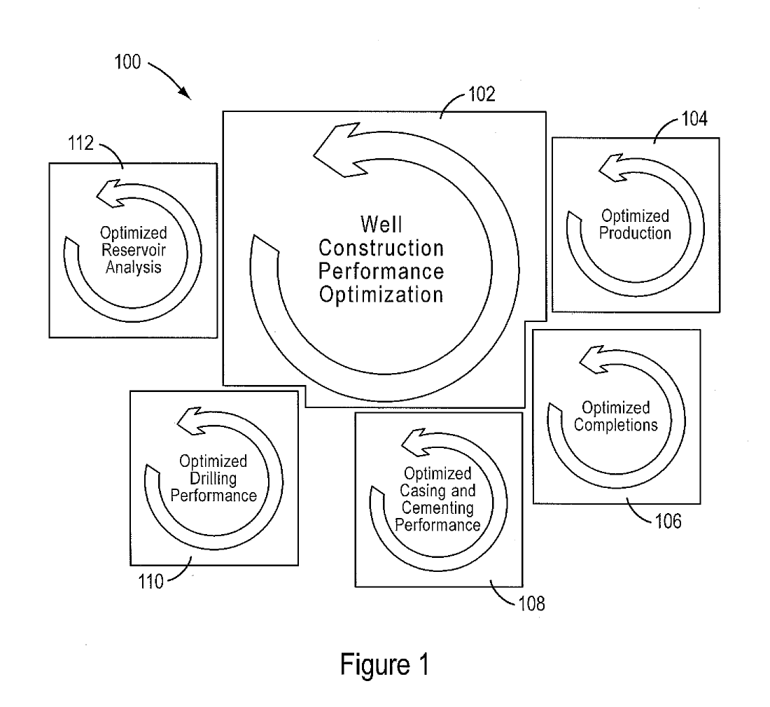

FIG. 1 illustrates schematically well construction performance optimization 100 according to some embodiments of the present invention. As illustrated in FIG. 1, several tasks involved in a well construction plan are being optimized. As shown in FIG. 1, a reservoir analysis 112, drilling performance 110, casing and cementing performance 108, completions 106, and production 104 each have optimization criteria. Additionally, through interaction 102, the combination of reservoir analysis 112, drilling performance 110, casing and cementing performance 108, completions 106, and products 104 are all optimized. Optimization may take several forms and may differ depending on the particular drilling situation. An optimum environment may, for example, emphasize drilling speed while another optimization may emphasize equipment longevity. Consequently, optimization may involve choosing the best products and drilling parameters to solve a particular defined problem, picking the best combination of products, and continually implementing and refining methods of solving the problems. FIG. 1 illustrates an example of performance optimization through the integration of workflows and services from different technology groups and different responsible parties.

As is further illustrated in FIG. 1, the optimization process can be performed on computers for each optimized task running at remote sites. Each of optimization processes 104, 106, 108, 110, and 112 can be optimization tools operating on individual computer systems that are in contact with a central server, represented by performance optimization 102. Each of optimization processes 104, 106, 108, 110, and 112 may fall within the responsibility of different engineering groups that are responsible for the design of certain aspects of the drilling process. As such, once one optimization process is completed, parameters that affect others of the optimization process are transferred through performance optimization 102 to each of the other processes. The well construction optimization process is complete when, through a loop of each of optimization processes 104, 106, 108, 110, and 112, no further changes in drilling parameters and design are completed. In some embodiments, a subset of all of the tasks utilized in a well drilling design can be optimized.

Therefore, well construction performance optimization 102 can be an optimization and design tools operating on a central server. Each of optimization processes 104, 106, 108, 110, and 112 can be individual computer systems that are coupled to performance optimization 102 and which operate design tools for designing a particular portion of the drilling construction process.

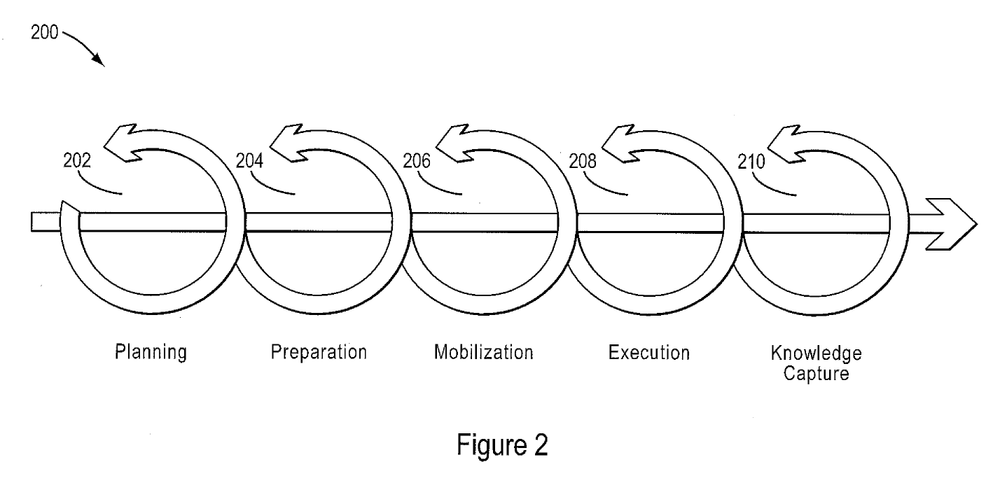

FIG. 2, then, illustrates an optimization flow 200 according to some embodiments of the invention. As shown in FIG. 2, individual tasks, which often operate as separate silos or stages during the well construction process, are integrated into one workflow. Planning 202, preparation 204, mobilization 206, execution 208, and knowledge capture 210, for example, can be integrated and optimized as a single workflow. For example, equipment delivery and system solutions can be chosen for optimal performance to minimize the impact on the drilling operation. Wellbore trajectories and integrity, rock destruction, drilling dynamics, and hydraulics management can be integrated. Finally, solutions and the results of those solutions can be captured through communications, knowledge management, and data storage and access facilities.

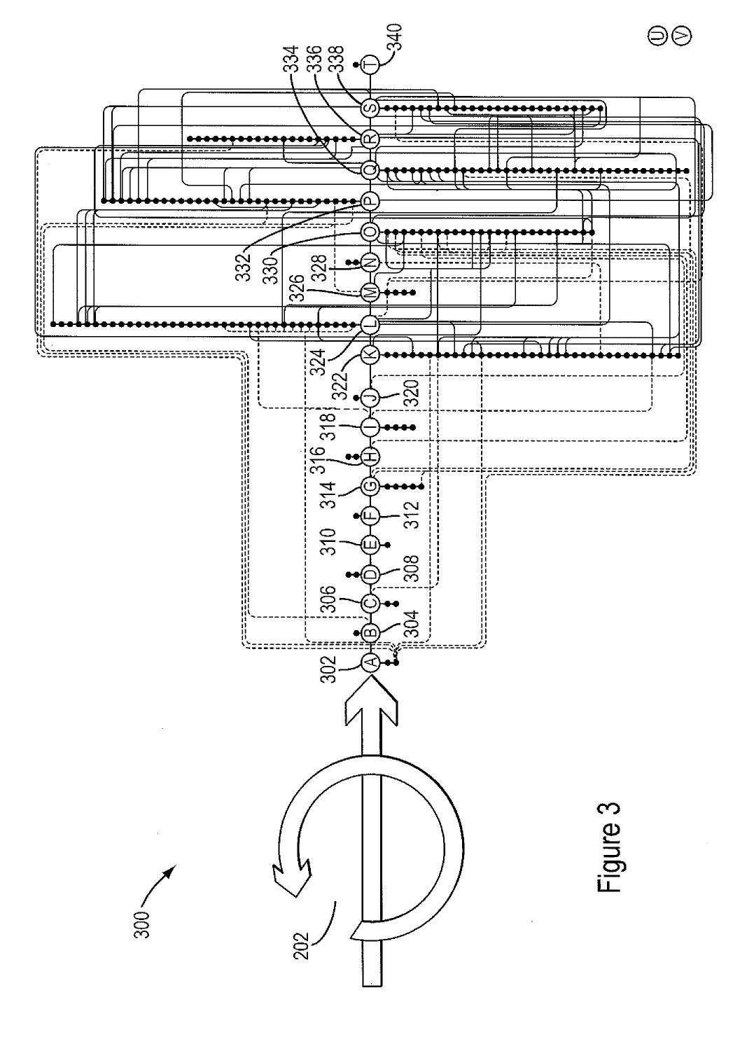

FIG. 3 illustrates a portion of the work flow environment 300. Optimization flow 202 can be depicted as a workflow environment 300. As shown in FIG. 3, workflow environment 300 can include individual design tasks. As illustrated in FIG. 3, the example of workflow environment 300 includes individual tasks 302-340, the final task 340 being to drill the well. Table 1 illustrates individual tasks 302-340: Task 302 represents the task “Obtain Target Location”; Task 304 represents the task “Determine Well Type”; Task 306 represents the task “Determine Reservoir Type, Extent of Reservoir, and Required Exposure”; Task 308 represents the task “Determine Production Requirements”; Task 310 represents the task “Determine Stimulation Requirements”; Task 312 represents the task “Determine Completion Hole Size”; Task 314 represents “Obtain Geological Information”; Task 316 represents the task “Reservoir Geomechanical Analysis”; Task 318 represents the task “Obtain Surface Location”; Task 320 represents the task “Obtain Environmental Limitations at Surface Location”; Task 322 represents “Design Well Trajectory”; Task 324 represents the task “Wellbore Integrity Analysis”; Task 326 represents the task “Casing Point Selection and Casing Point Design”; Task 328 represents the task “Cement Design”; Task 330 represents the task “Drilling Fluids Design”; Task 332 represents the task “Drill Bit and Hole Enlargement Design”; Task 334 represents the task “Bottom Hole Assembly (BHA) Design”; Task 336 represents the task “Drillstring Design”; Task 338 represents the task “Hydraulics Design”; and task 340 represents the task “Well Drilling”.

As is further illustrated in FIG. 3, each of tasks 302 through 340 includes one or more sub-tasks (designated by individual dots associated with the individual task). As tasks 302 through 340 are labeled tasks A through T, the subtasks are labeled with the task letter and a number. Table 1 provides a list of subtasks for each of tasks 302 through 340 illustrated in workflow environment 300 illustrated in FIG. 3. As indicated in the table, and illustrated in FIG. 3, task 302 includes subtasks A1-A2; task 304 includes subtask B1; task 306 includes subtasks C1-C2; task 308 includes subtasks D1-D2; task 310 includes subtask E1; task 312 includes subtask F1; task 314 includes subtasks G1-G5; task 316 includes subtask F1; task 318 includes subtasks I1-I4; task 320 includes subtask J1; task 322 includes subtasks K1-K35; task 324 includes subtasks L1-L36; task 326 includes subtasks M1-M4; task 328 includes subtasks N1-N2; task 330 includes subtasks O1-O26; task 332 includes subtasks P1-P30; task 334 includes subtasks Q1-Q36; task 336 includes tasks R1-R20; task 338 includes tasks S1-S26; and task 340 includes task T1.

As is further illustrated in FIG. 3, design choices and parameters utilized in the steps leading to a particular design task affect other steps in other design tasks. Subtasks from each of tasks 302 through 340 can be defined by the technical group that completes that task. Further, each technical group, in defining workflow 300, indicates data and parameters that are utilized or determined in other subtasks or tasks in workflow 300. Before optimization of the well construction process, subtasks for each of tasks 302 through 340 and their linkages to other subtasks of tasks 302 through 340 are determined.

In performing the optimization, multiple iterations arrive at a design that optimizes the entire well drilling process rather than concentrating on designs that optimize particular design tasks. FIG. 3 illustrate the interlinking parameters that can be utilized in optimization of tasks 322 (Design Well Trajectory), 324 (Wellbore Integrity Analysis), 330 (Drilling Fluids Design), 332 (Drill Bit and Hole Enlargement Design), 334 (Bottom Hole Assembly Design), 336 (Drillstring Design), and 338 (Hydraulics Design). FIG. 3 illustrates links between subtasks of the tasks that include parameters that are utilized to optimize the entire workflow. For clarity, the links are also provided in Table 1.

Therefore, referring back to FIG. 3 and the drilling workflow 202 defined by the tasks 322 (Design Well Trajectory), 324 (Wellbore Integrity Analysis), 330 (Drilling Fluids Design), 332 (Drill Bit and Hole Enlargement Design), 334 (Bottom Hole Assembly Design), 336 (Drillstring Design), and 338 (Hydraulics Design) illustrated in FIG. 3, workflow 300 can optimize the drilling environment for optimal equipment and equipment delivery solutions as well as system solutions. As is understood, workflow 300 can be utilized to optimize the drilling environment for any optimization goal or set of optimization goals.

Optimization can have many definitions. As is understood, workflow 300 can be utilized to optimize the drilling environment for any optimization goal or set of optimization goals. Every drilling design has a unique optimum configuration where the well construction includes, but is not limited to, the following minimum criteria: The path the well will take from the surface through the overburden rock and through the reservoir rock; Knowledge of the overburden rock and reservoir rock mechanical properties, in situ stresses, formation fluid pressure and formation collapse and fracture pressure; The selection and design of the drilling fluid and its rheological properties to maintain the wellbore pressures, clean the hole, cool the bit and transmit hydraulic energy; The selection and design of the drill bits appropriate for drilling the overburden rock and reservoir rock; The design of the Bottom Hole Assembly (BHA) to deliver the directional drilling performance required by the trajectory design and to convey downhole measurement tools; The design of the drillstring to transmit mechanical energy from surface to the bit withstand the static and dynamic frictional drag in the well bore due to the movement of the drill string; the design of the hydraulics requirements for the drilling fluid flow rate, flow regime and pressure regime inside drillstring, through the bit and though the annulus between the drillpipe and the wellbore and between the drillpipe and the casing and the marine riser if present. Each of these criteria places restrictions on the wellbore constructions. The optimal well design falls within each of the restrictions that are placed on the wellbore constructions.

As illustrated in FIGS. 1 and 2, workflow 300 can be iterated based on the linked parameters to optimize the designed drilling environment for a particular set of optimization goals. In some embodiments, not all drilling workflow tasks may be included in the optimization process. For example, the workflow may include tasks 322 (Design Well Trajectory), 324 (Wellbore Integrity Analysis), 332 (Drill Bit and Hole Enlargement Design), and 334 (Bottom Hole Assembly Design) and not include other tasks in the optimization. Another workflow may integrate and optimize 330 (Drilling Fluids Design), 332 (Drill Bit and Hole Enlargement Design), 334 (Bottom Hole Assembly Design), and 336 (Drillstring Design). Yet another may optimize a combination of all of the individual workflows: task 322 (Design Well Trajectory), task 324 (Wellbore Integrity Analysis), task 330 (Drilling Fluids Design), task 332 (Drill Bit and Hole Enlargement Design), task 334 (Bottom Hole Assembly Design), task 336 (Drillstring Design), and task 338 (Hydraulics Design).

Optimization of workflows in accordance with some embodiments of the present invention may result in higher performance and less drilling time. Optimization may result in bonuses for completion, contract deliveries, extended and improved contract terms, increased market share at better margins, performance bonuses, better footage rates, and increased equipment lifetimes. Optimization criteria may be based on rate of penetration, lessening of non-productive time, meeting of production targets, meeting of AFE, or other requirements. Optimization criteria may be based on combinations of factors. The results of the optimization process provides for a drilling design for that optimization criteria.

Table 1 illustrates particular tasks in workflow 300, the entity that usually performs that task (although the task may be formed by others as well), and which other tasks included in workflow 300 provide inputs to or receive outputs from the performance of the particular tasks. The example of workflow 300 provided in FIG. 3 and Table 1 is exemplary only. Other workflows can be utilized with embodiments of the present invention.

TABLE 1

| Sub- | | | |
|---|---|---|---|
| Task | Description | Responsible Entity | Links |
| A. Task 302: Obtain Target Location | | | |
| A1 | Obtain Geographic Coordinates | | |
| | and coordinate system for the | | |
| | target | | |
| A2 | Carry out a database search for | | K6, K12, K31, |
| | offset wells already drilled and | | L1, L2, L3, L4, |
| | review relevant well designs, | | L6, L7, L8, L9, |
| | plots, logs and end of well | | L16, O7, O15, |
| | reports. | | O16, P11, R15 |
| B. Task 304: Determine Well Type | | | P3 |
| B1 | Exploration, Production, | | |
| | Injection, Re-entry | | |
| C. Task 306: Determine Reservoir Type, Extent of Reservoir, and | | | K7 |
| Required Exposure | | | |
| C1 | Vertical, Hz, Length | | |
| C2 | Obtain Reservoir Type and | | |
| | trapping mechanism | | |
| D. Task 308: Determine Production Requirements | | | |
| D1 | Determine Hydrocarbon | | |
| | requirements, Oil, Gas, | | |
| | Condensate, Water, Ratios and | | |
| | Production Volumes | | |
| D2 | Determine production method | | |
| | Flowing, Pumping, Artificial | | |
| | Lift, determine Longevity of | | |
| | production and required | | |
| | production hole size | | |
| E. Task 310: Determine Stimulation Requirements | | | |
| E1 | Fracturing, Acidization, Steam | | |
| | assisted gravity drainage | | |
| | (Sagd), Pressure maintenance | | |
| | (injection) | | |
| F. Task 312: Determine Completion Hole Size | | | |
| F1 | Obtain required hole size at TD | | |
| | for required completion | | |
| G. Task 314: Obtain Geological Information | | | O3, O13 |
| G1 | Obtain Formation Tops | | |
| G2 | Obtain Formation Types | | |
| G3 | Obtain Depositional | | |
| | Environment | | |
| G4 | Obtain Formation Temperature | | Q10, Q15 |
| | Profile | | |
| G5 | Obtain Reservoir formation | | O2 |
| | type and properties | | |
| H. Task 316: Reservoir Geomechanical Analysis | | | O2, O13 |
| H1 | Perform geomechanical | | |
| | analysis on the reservoir for | | |
| | sanding, and fracturing | | |
| | requirements | | |
| H2 | Review well path design based | | |
| | on results of reservoir | | |
| | geomechanics analysis | | |
| I. Task 318: Obtain Surface Location | | | K32, L12 |
| I1 | Onshore or Offshore | Obtained from customer by DD | |
| | | Coordinator, Well Planner updates | |
| | | plans | |
| I2 | Obtain Geographic Coordinates | Obtained from customer by DD | |
| | and coordinate system for the | Coordinator, Well Planner checks | |
| | surface location | when starting on new plan | |
| I3 | Obtain reference Datum | Obtained from customer by DD | |
| | elevations. Ensure it is the | Coordinator, Well Planner checks | |
| | correct system Vertical datum. | when starting on new plan | |
| I4 | For Offshore Locations obtain | Obtained from customer by DD | |
| | planned water depth, determine | Coordinator, Drilling Fluid | |
| | if well is deepwater/ultra- | Specialist | |
| | deepwater | | |
| J. Task 320: Obtain Environmental Limitations at Surface Location | | | O5 |
| J1 | Zero discharge, drilling fluid | Obtained from customer | |
| | limitations, Noise restrictions | | |
| K. Task 322: Design Well Trajectory | | | O12, Q2 |
| K1 | Obtain Customer Reference | DD Coordinator, Well Planner, | |
| | Documentation. Tool | Survey Manager | |
| | instrument performance model | | |
| | files, anti-collision practices, | | |
| | drilling and surveying practices | | |
| K2 | Determine Single/Multi well | DD Coordinator, Well Planner, | |
| | path design | Survey Manager | |
| K3 | Determine Geological Target | Obtained from customer by DD | |
| | (s) | Coordinator, Well Planner updates | |
| | | plans | |
| K4 | Determine Drillers Target(s) | Obtained from customer by DD | R4 |
| | | Coordinator, Well Planner updates | |
| | | plans | |
| K5 | Determine the boundaries of | Customer/Well Planner | |
| | any lease line or block | | |
| K6 | Obtain offset well survey | Obtained by DD Coordinator, | A2 |
| | information and QA type of | Well Planner updates plans | |
| | surveys to determine correct | | |
| | instrument performance model. | | |
| K7 | Determine any zones to avoid | Customer, DD Coordinator, Well | C, O7, Q2, |
| | penetrating, (Injection/ | Planner | |
| | production/cuttings injection/ | | |
| | subsidence). | | |
| K8 | Determine inclination | Customer, DD Coordinator, Well | |
| | limitations for Top hole section, | Planner | |
| | riserless section or entire | | |
| | wellbore. | | |
| K9 | Determine inclination and | Customer, DD Coordinator, Well | L |
| | azimuth sensitivities for | Planner | |
| | borehole stability | | |
| K10 | Determine inclination and | Customer, DD Coordinator, Well | R |
| | azimuth sensitivities for Torque | Planner | |
| | and Drag limitations. | | |
| K11 | Determine formation tendencies | Customer, DD Coordinator, Well | Q3 |
| | for build/drop/turn rates. | Planner | |
| K12 | Identify formations that are | DD Coordinator, Well Planner | A2, L5 |
| | difficult/impossible to steer in | | |
| | or have ‘natural’ formation | | |
| | tendencies | | |
| K13 | Plan Well Path aiming to | DD Coordinator, Well Planner | |
| | continually diverge from all | | |
| | existing wells from the kick off | | |
| | point. | | |
| K14 | Plan to minimize Doglegs in | DD Coordinator, Well Planner | |
| | top hole sections. | | |
| K15 | Perform Anti collision | DD Coordinator, Well Planner | |
| | Analysis, review high risk wells | | |
| | and report to the customer. | | |
| K16 | Determine if gyro or steering | DD Coordinator, Well Planner | |
| | tools are required because of | | |
| | magnetic interference. | | |
| K17 | Establish the effect of TVD | DD Coordinator, Well Planner, | Q |
| | uncertainties especially when | Survey Manager | |
| | planning horizontal The effect | | |
| | of TVD uncertainty, due to both | | |
| | geology and survey error should | | |
| | be accounted for in the plan so | | |
| | that well can still be landed | | |
| | within the dogleg capability of | | |
| | the equipment. | | |
| K18 | Establish the effect of drilling | DD Coordinator, Well Planner, | |
| | close to magnetic east west and | Survey Manager | |
| | close to horizontal, based on the | | |
| | latitude of the well. | | |
| K19 | Determine length of Rat hole | Customer/DD Coordinator, Well | L5 |
| | required at TD for logging tools | Planner, Survey Manager | |
| K20 | Determine differential sticking | Customer | Q |
| | risk. Compensate within | | |
| | wellplan for build and drop | | |
| | above and below the risk zone | | |
| | as sliding may result in stuck | | |
| | pipe. | | |
| K21 | Perform Anti collision | Customer, DD Coordinator, Well | Q7 |
| | Analysis, review high risk wells | Planner | |
| | and report to the customer. | | |
| K22 | Consider options for collision | DD Coordinator, Well Planner | Q |
| | avoidance should the | | |
| | directional plan not be achieved | | |
| K23 | Determine if sidetracks are | Customer, DD Coordinator, Well | |
| | Planned | Planner | |
| K24 | When sidetracking an existing | DD Coordinator/Well Planner | |
| | wellbore review QA | | |
| | information of main bore and | | |
| | generate definitive survey | | |
| | listing | | |
| K25 | When sidetracking an existing | DD Coordinator/Customer | |
| | wellbore determine if the | | |
| | location of the KOP is in open | | |
| | hole or inside casing and obtain | | |
| | hole diameter | | |
| K26 | When sidetracking an existing | DD Coordinator/Customer | N |
| | wellbore determine the top of | | |
| | the cement in open hole or | | |
| | behind casing. | | |
| K27 | When sidetracking an existing | DD Coordinator/Customer | |
| | wellbore determine the Kick off | | |
| | method, (open hole, cement | | |
| | plug, whipstock) | | |
| K28 | When Sidetracking an existing | DD Coordinator/Well | |
| | wellbore produce Ladder plots | Planner/Survey Manager | |
| | or travelling cylinder and | | |
| | clearance listings in sufficient | | |
| | detail to show the planned | | |
| | divergence from the parent | | |
| | well, casing stumps and the | | |
| | zones of magnetic interference. | | |
| K29 | When sidetracking determine | DD Coordinator/Well | |
| | the requirement for gyro singles | Planner/Survey Manager | |
| | shots, gyro multishots, or gyro | | |
| | MWD over the zone of | | |
| | magnetic interference Any risk | | |
| | of collision shall be | | |
| | documented | | |
| K30 | When Sidetracking Perform | DD Coordinator/survey | |
| | Anti collision Analysis, review | management | |
| | high risk wells and report to the | | |
| | customer. | | |
| K31 | QA check proposed well design | DD Coordinator | A2 |
| | with offset well performance | | |
| K32 | Review surface location | Customer/DD Coordinator | I |
| | position to determine if well | | |
| | path design can be improved by | | |
| | modifying it. | | |
| K33 | Review Torque and Drag for | Customer/DD Coordinator | R |
| | Drillstring and Casing to | | |
| | determine if well path design | | |
| | can be improved by modifying | | |
| | it. | | |
| K34 | Review Fluid Design, | Customer/DD Coordinator | O, S |
| | Hydraulics and hole cleaning to | | |
| | determine if well path design | | |
| | can be unproved by modifying | | |
| | it. | | |
| K35 | Review Bottom Hole Assembly | Customer/DD Coordinator | Q |
| | Designs to determine if | | |
| | directional performance can be | | |
| | optimized by modifying the | | |
| | well path design | | |
| L. Task 324: Wellbore Integrity Analysis | | | K9, K32, M1, |
| | | | O1, O3, O13, Q4 |
| L1 | Obtain locations of offset wells | Pore Pressure Engineer/ | A2 |
| | with Latitude and Longitude | Geomechanics Specialist | |
| L2 | Obtain offset data sets | Pore Pressure Engineer/ | A2 |
| | (resistivity, sonic, gamma ray, | Geomechanics Specialist | |
| | SP, RHOB, porosity) for all | | |
| | analogue wells including | | |
| | surveys for directional wells | | |
| | and image logs sufficient to | | |
| | perform Pore pressure | | |
| | prediction and rock property | | |
| | calculations. | | |
| L3 | Obtain any pore pressure | Pore Pressure Engineer/ | A2 |
| | calibration data from offset | Geomechanics Specialist | |
| | wells such as MDTs, kicks, | | |
| | mud weights or actual offset | | |
| | reservoir pressures. | | |
| L4 | Obtain simple geologic cross- | Pore Pressure Engineer/ | A2 |
| | sections with major formation | Geomechanics Specialist | |
| | ages, paleo markers, any major | | |
| | structural features, key horizons | | |
| | and targets. | | |
| L5 | Perform Hazard identification | Pore Pressure Engineer/ | K19, K12, O16 |
| | (salt, Rubble zones, faults, | Geomechanics Specialist | |
| | fractured zones, vuggy or karst | | |
| | formations) | | |
| L6 | Obtain Seismic cross-sections | Pore Pressure Engineer/ | A2 |
| | showing targets and | Geomechanics Specialist | |
| | relationships to analogue wells | | |
| | along with depth vs. two-way | | |
| | time conversions. | | |
| L7 | Obtain Stacking velocities | Geomechanics Specialist | A2 |
| | and/or original CDP gathers and | | |
| | RMS volumes if a seismic pore | | |
| | pressure volume from | | |
| | reprocessed seismic is | | |
| | requested. | | |
| L8 | Obtain Drilling data (gas, | Pore Pressure Engineer/ | A2 |
| | torque and drag, Dxc, mud | Geomechanics Specialist | |
| | temp, conductivity, etc) and | | |
| | histories of offset wells with | | |
| | any hole problems, lost | | |
| | circulation, LOTs, casing | | |
| | points, sidetracks, etc. Mud logs | | |
| | or End of Well reports | | |
| L9 | From structural and | Pore Pressure Engineer/ | O21 |
| | stratigraphic geological | Geomechanics Specialist | |
| | information evaluate the | | |
| | potential pore pressure | | |
| | mechanisms active within the | | |
| | prospect. Determining pressure | | |
| | in permeable and impermeable | | |
| | formations and driven by | | |
| | compaction, temperature, | | |
| | chemical and hydrodynamic | | |
| | effects | | |
| L10 | Obtain rig Datums for offset | Pore Pressure Engineer, | A2 |
| | wells | Geomechanics Specialist | |
| L11 | Obtain Water depths for offset | Pore Pressure Engineer, | A2 |
| | offshore wells | Geomechanics Specialist | |
| L12 | Obtain Planned rig Datums and | Pore Pressure Engineer, | I |
| | for offshore wells the planned | Geomechanics Specialist | |
| | water depth and air gap | | |
| L13 | Determine any potential zones | Pore Pressure Engineer, | K19 |
| | of under pressure or depletion | Geomechanics Specialist | |
| L14 | Establish Shallow Gas and | Pore Pressure Engineer, | |
| | Shallow water flow risk, | Geomechanics Specialist | |
| | presence of hydrates and | | |
| | estimate pressures within | | |
| | centroids. | | |
| L15 | Determine if 1d, 3d or basin | Pore Pressure Engineer, | |
| | modelling is required and can | Geomechanics Specialist | |
| | be performed | | |
| L16 | Determine lithology column on | Pore Pressure Engineer, | A2 |
| | offset wells | Geomechanics Specialist | |
| L17 | Generate Overburden Gradient | Pore Pressure Engineer, | |
| | from composite bulk density | Geomechanics Specialist | |
| | profile | | |
| L18 | For 1d analysis perform shale | Pore Pressure Engineer, | |
| | discrimination, shale volume | Geomechanics Specialist | |
| | and shale index calculations on | | |
| | offset data. | | |
| L19 | For 1d analysis establish | Pore Pressure Engineer, | |
| | compaction trend lines through | Geomechanics Specialist | |
| | the offset log data | | |
| L20 | For 1d analysis Calculate Pore | Pore Pressure Engineer, | |
| | Pressure from each data source | Geomechanics Specialist | |
| L21 | For 1d analysis Examine | Pore Pressure Engineer, | |
| | Qualitative pore pressure data | Geomechanics Specialist | |
| | sets | | |
| L22 | Compare pore pressure | Pore Pressure Engineer, | |
| | predictions to offset MW, ECD | Geomechanics Specialist | |
| | and PWD information | | |
| L23 | Determine Definitive Pore | Pore Pressure Engineer, | |
| | Pressure from offset wells | Geomechanics Specialist | |
| L24 | Calculate Fracture Pressure | Pore Pressure Engineer, | |
| | using available methods, | Geomechanics Specialist | |
| | lithology information and LOT | | |
| | measurements | | |
| L25 | Determine Definitive Fracture | Pore Pressure Engineer, | |
| | Pressure from offset wells | Geomechanics Specialist | |
| L26 | For 3d Analysis obtain seismic | Geomechanics Specialist | |
| | cube | | |
| L27 | For 3d Analysis analyze seismic | Geomechanics Specialist | |
| | cube to calculate Density | | |
| | profile, Overburden gradient, | | |
| | Pore Pressure and Fracture | | |
| | pressure. | | |
| L28 | Extract PP, FP, OB for | Geomechanics Specialist | |
| | proposed well path from | | |
| | Seismic cube | | |
| L29 | For Basin Pore Pressure model | Geomechanics Specialist | |
| | obtain stratigraphy, | | |
| | sedimentation rates and fault | | |
| | locations. | | |
| L30 | Calibrate basin PP model to | Geomechanics Specialist | |
| | offset well pore pressure data. | | |
| L31 | For Wellbore Stability | Geomechanics Specialist | O16, P11 |
| | Calculations determine Shmin | | |
| | from LOT and Fracture | | |
| | information | | |
| L32 | For Wellbore Stability | Geomechanics Specialist | O16, P11 |
| | Calculations constrain Shmax | | |
| | from evidence of wellbore | | |
| | failure | | |
| L33 | For Wellbore Stability | Geomechanics Specialist | O16, P11 |
| | Calculations determine Rock | | |
| | properties (UCS, CCS, Friction | | |
| | Angle, Vshale) from offset log | | |
| | data and regionally established | | |
| | correlations | | |
| L34 | For Wellbore Stability | Geomechanics Specialist/Drilling | |
| | Calculations determine | Fluid Specialist | |
| | chemical sensitivities between | | |
| | the drilling fluid and formations | | |
| L35 | For Wellbore Stability | Geomechanics Specialist | |
| | Calculations calculate collapse | | |
| | pressure using most applicable | | |
| | failure criteria, PP, OB, Shmin, | | |
| | Shmax and rock properties. | | |
| L36 | Review well path design based | | J9 |
| | on results of wellbore integrity | | |
| | analysis | | |
| M. Task 326: Casing Point Selection/Casing Design | | | O3 |
| M1 | Define Required Mud Windows | | L, O21, O26, S2 |
| | from Pore Pressure/Collapse | | |
| | Pressure/Fracture Pressure | | |
| | limits | | |
| M2 | Determine Casing sizes and | | |
| | shoe depths | | |
| M3 | Determine Casing Yield/ | | |
| | Collapse Requirements | | |
| M4 | Determine MAASP/Kick | | |
| | Tolerance | | |
| N. Task 328: Cement Design | | | K26 |
| N1 | Design Slurry and spacer | | |
| | requirements | | |
| N2 | Determine Requirements: | | |
| | Single/Multistage Cement job | | |
| O. Task 330: Drilling Fluids Design | | | K34, S5 |
| O1 | Obtain reservoir requirements, | Drilling Fluid Specialist/Customer | A2, L |
| | geological objectives, reservoir | | |
| | description (lithology column | | |
| | for well path), fault formation, | | |
| | temperature profile, casing | | |
| | design, PP/FG plots | | |
| O2 | Determine if the reservoir calls | Drilling Fluid | H, G5 |
| | for a drill-in fluid or other | Specialist/Customer/Drilling | |
| | specialized system | Fluid Technical Group | |
| O3 | Determine the appropriate fluid | Drilling Fluid | L, M, G |
| | types and technologies for the | Specialist/Customer/Drilling | |
| | specific well/project and | Fluid Technical Group | |
| | sections/intervals | | |
| O4 | Determine the completion fluid | Drilling Fluid | |
| | requirements | Specialist/Customer/Drilling | |
| | | Fluid Technical Group | |
| O5 | Determine the local | Drilling Fluid | J |
| | environment regulations | Specialist/Customer/Health, | |
| | | Safety and Environment Specialist | |
| O6 | Determine what the drilling | Drilling Fluid Specialist/Drilling | |
| | waste profile associated with | Fluid Surface Solutions Tech | |
| | the project is | Professional/Customer | |
| O7 | Determine if there are special | Drilling Fluid Specialist/Well | A2, K7 |
| | challenges of this well (e.g., | Planner/Customer | |
| | deepwater, HPHT, logistical | | |
| | issues, depleted zones, | | |
| | formation damage, etc) that | | |
| | affects the fluid design. | | |
| O8 | Determine need for customized | Drilling Fluid Specialist/Drilling | |
| | solutions/new technology | Fluid Technical Group | |
| O9 | Determine if this is a critical | Drilling Fluid Specialist/Drilling | |
| | first well | Fluid Technical Group | |
| O10 | Determine if the well calls for | Drilling Fluid Specialist/Customer | |
| | specialized lab equipment | | |
| O11 | Determine if wellbore stability | Drilling Fluid Specialist/Customer | L |
| | modeling is required | | |
| O12 | Determine if there are any | Drilling Fluid Specialist/Customer | K, K34 |
| | challenges with regard to the | | |
| | hole cleaning, angle of well that | | |
| | requires modification to the | | |
| | drilling fluid | | |
| O13 | Evaluate need for lab testing to | Drilling Fluid Specialist/Drilling | G, H, L |
| | determine if the mud system is | Fluid Technical Group | |
| | suited for drilling under the | | |
| | planned well conditions | | |
| O14 | Perform lab tests to determine | Drilling Fluid Specialist/Drilling | |
| | composition of LCM pills or | Fluid Technical Group | |
| | Wellset treatment if required. | | |
| O15 | Obtain data from offset wells or | Drilling Fluid Specialist | A2 |
| | wells that have been drilled | | |
| | under similar conditions to get | | |
| | an understanding of what could | | |
| | be expected for the next well to | | |
| | be drilled. | | |
| O16 | Design LCM decision trees or | Drilling Fluid Specialist/Drilling | A2, L5, L31, |
| | matrix based on formations to | Fluid Technical Group | L32, L33 |
| | be drilled. | | |
| O17 | Determine stuck pipe | Drilling Fluid Specialist/Drilling | |
| | procedures and required | Fluid Technical Group | |
| | treatments | | |
| O18 | Create a Basis of Design | Drilling Fluid Specialist | |
| O19 | Create a Total Fluid | Drilling Fluid Specialist | |
| | Management Program | | |
| O20 | Create Drilling Fluid Program | Drilling Fluid Specialist | |
| O21 | Perform mud formulation based | | M1, L9 |
| | on given formation pressure/ | | |
| | anticipated hole problems | | |
| O22 | Select mud type/properties for | | |
| | each hole section | | |
| O23 | Specify mud properties mud wt/ | | |
| | yield point/gel strength/pH/ | | |
| | MBT/Chloride/Solid content/ | | |
| | Filtrate | | |
| O24 | Run hydraulic analysis for each | | K34, S, Q9 |
| | hole section and estimate the | | |
| | Optimum ROP/gpm to | | |
| | minimize cutting load in the | | |
| | annulus | | |
| O25 | Determine mud wt schedule for | | M1, Q1, Q10, |
| | each hole section. | | Q15, Q26, Q35, |
| | | | R4, R12 |
| O26 | Obtain reservoir requirements, | Drilling Fluid Specialist/Customer | A2, L |
| | geological objectives, reservoir | | |
| | description (lithology column | | |
| | for well path), fault formation, | | |
| | temperature profile, casing | | |
| | design, PP/FG plots | | |
| P. Task 332: Drill Bit and Hole Enlargement Design | | | |
| P1 | Obtain offset data and bit | Bit Sales rep/Bit Applications | A2 |
| | performance information | Engineer | |
| P2 | Determine operational | Customer | |
| | constrains (i.e. type of rig, | | |
| | pump capacity) | | |
| P3 | Determine type of well and | Customer | B, M |
| | casing design | | |
| P4 | Study offset data from bit | Bit Sales rep/Applications | |
| | database and identify potential | Engineer | |
| | improvements | | |
| P5 | Formulate bit selection based | Bit Sales rep/Bit Applications | P17 |
| | on existing designs or if new | Engineer | |
| | design is required | | |
| P6 | Obtain ROP targets | Bit Sales rep/Bit Applications | |
| | | Engineer/DD Coordinator | |
| P7 | Determine directional | Bit Applications Engineer/DD | |
| | requirements | Coordinator | |
| P8 | Obtain rock strength and | Bit Applications Engineer | L33 |
| | overbalance (MW-PP) | | |
| P9 | Obtain formation properties | Bit Sales rep/Applications | |
| | | Engineer | |
| P10 | Obtain formation tops and | BitSales rep/Applications | |
| | amount of interbedding | Engineer | |
| P11 | Obtain offset Log data, Pore | Bit Performance Engineer/Sales | A2, L31, L32, |
| | Pressure and Perform Bit | rep | L33 |
| | performance Analysis | | |
| P12 | Bit Type Selection | Bit Sales rep/Bit Applications | |
| | | Engineer/DD Coordinator | |
| P13 | Match Bit Selection to Bottom | Bit Specialist/DD Coordinator | Q |
| | Hole Assembly and drive | | |
| | system (Motor/RST/Rotary) | | |
| P14 | Determine hole enlargement | Bit Sales rep/Applications | |
| | requirements and ratio of pilot | Engineer | |
| | hole to opened hole diameter | | |
| P15 | Select the hole opener or | Bit Applications Engineer | S9 |
| | reamer to meet hole opening | | |
| | requirements | | |
| P16 | Match the hole opener or | Bit Applications Engineer/DD | Q |
| | reamer to Bottom Hole | Coordinator | |
| | Assembly and drive system | | |
| | (Motor/RST/Rotary) | | |
| P17 | Match the bit and hole opener | Bit Applications Engineer/DD | |
| | cutting structures to balance the | Coordinator | |
| | penetration rates | | |
| P18 | For new bit design perform | Bit Applications Engineer/ | |
| | rock strength analysis using | Applications Design Engineer | |
| | offset log data | | |
| P19 | For new bit design Obtain bit | Bit Applications Engineer | |
| | FRR with dull bit photos | | |
| P20 | For new bit design Determine | Bit Applications Engineer/ | |
| | areas for improvement and | Applications Design Engineer | |
| | define design criteria | | |
| P21 | For new bit design optimum | Applications Design Engineer | |
| | cutting structure and gage | | |
| | configuration | | |
| P22 | Recommend best drilling | Bit Applications Engineer/ | |
| | practice for selected bit and | Applications Design Engineer | |
| | hole enlargement | | |
| P23 | Perform bench mark analysis of | Applications Design Engineer | |
| | selected equipment to target | | |
| | ROP | | |
| P24 | Determine ROP Capability | Applications Design Engineer | |
| P25 | Determine Bit/hole | Bit Applications Design Engineer | R3 |
| | enlargement Torque | | |
| | requirements | | |
| P26 | Determine bit/hole | Bit Applications Engineer/Bit | S, S7 |
| | enlargement hydraulics | Applications Design Engineer | |
| | requirements HSI/IF | | |
| P27 | Determine Bit/hole | Bit Applications Engineer/Bit | Q |
| | enlargement Weight | Applications Design Engineer | |
| | requirements | | |
| P28 | Determine Bit/hole | Bit Applications Engineer/Bit | Q, Q35 |
| | enlargement Speed | Applications Design Engineer | |
| | requirements | | |
| P29 | Determine Bit/hole | Bit Applications Engineer/Bit | S, S26 |
| | enlargement nozzle selection | Applications Design Engineer | |
| | and Flow rate requirements | | |
| P30 | Determine flow rates/pressures | Bit Applications Engineer | S |
| | to activate reamers | | |
| Q. Task 334: Bottom Hole Assembly Design | | | K17, K20, K22, |
| | | | K35, P13, P16, |
| | | | P27, P28, R9, |
| | | | S24 |
| Q1 | Obtain Wellbore trajectory, | DD Coordinator | K, O26 |
| | wellbore schematic with hole | | |
| | size start and end depths and | | |
| | mud weight schedule | | |
| Q2 | Obtain Build/Drop/ | DD Coordinator | K, K7, K11 |
| | Equilibrium Rate | | |
| | Requirements/Limitations and | | |
| | target tolerances | | |
| Q3 | Obtain formation tendencies | DD Coordinator/Well Planner | K11 |
| Q4 | Obtain information on known | DD Coordinator/Pore Pressure | L |
| | borehole stability issues | Engineer | |
| Q5 | Determine hole opening/ | Customer/Fluid Specialist/Well | P14 |
| | reaming requirements | Planner/DD Coordinator | |
| Q6 | Obtain TVD uncertainties to | DD Coordinator | K17 |
| | ensure sufficient dogleg | | |
| | capability is available from the | | |
| | design | | |
| Q7 | Obtain Anti-collision program | DD Coordinator/Well Planner | K21 |
| Q8 | Obtain Rig Limitations - | Customer/DD Coordinator | |
| | Tubular handling maximum | | |
| | length, Torque Limitations, | | |
| | RPM Capacity, Derrick Load | | |
| | Capacity, Crane Capacity | | |
| Q9 | Obtain minimum flow rate | | S, O24 |
| | required for hole cleaning | | |
| Q10 | Determine maximum pressure | DD Coordinator/M/LWD | G4, O26 |
| | and temperature requirements | Coordinator | |
| | of the equipment | | |
| Q11 | Determine bit drive system | DD Coordinator/Bit Specialist | |
| Q12 | Rotary Assembly - packed, | DD Coordinator | |
| | pendulum or build | | |
| Q13 | Motor Assembly - slick or | DD Coordinator | S25 |
| | stabilized | | |
| Q14 | Select Motor Speed and Torque | DD Coordinator/Bit Applications | S8 |
| | based on Bit Requirements and | Engineer | |
| | flow rate range | | |
| Q15 | Select Motor Elastomer based | DD Coordinator/Bit Applications | S, O26, G4 |
| | on pressure and temperature | Engineer | |
| | requirements | | |
| Q16 | Rotary Steerable Assembly - | DD Coordinator | |
| | vertical or build | | |
| Q17 | Determine M/LWD Strategy | DD Coordinator/M/LWD | |
| | | Coordinator/Customer | |
| Q18 | Determine Telemetry System | M/LWD Coordinator | S10, S11 |
| | and Downlink requirements | | |
| Q19 | Determine Survey | DD Coordinator/Survey Manager | |
| | Requirements and magnetic | | |
| | spacing | | |
| Q20 | Determine Survey Management | | |
| | options. IFR, IIFR, Multi- | | |
| | station Analysis | | |
| Q21 | Determine required Formation | Customer/DD | |
| | Measurements/Logging | Coordinator/M/LWD Coordinator | |
| | Program within each hole | | |
| | section | | |
| Q22 | Determine required downhole | Customer/DD | |
| | Drilling Measurements within | Coordinator/M/LWD Coordinator | |
| | each hole section | | |
| Q23 | Select equipment that meets all | DD Coordinator/M/LWD | S |
| | the measurement, steering and | Coordinator | |
| | environmental requirements. | | |
| Q24 | Obtain M/LWD tool | DD Coordinator/M/LWD | |
| | configuration, Tool OD, ID and | Coordinator | |
| | stiffness information | | |
| Q25 | Analysis | | |
| Q26 | Obtain mud weight schedules | DD Coordinator | O26 |
| | and calculate buoyancy | | |
| | factor(s) | | |
| Q27 | Determine the neutral point | DD Coordinator/Well Planner | |
| | design factor or safety factor | | |
| Q28 | Calculate Jar Placement | DD Coordinator | |
| Q29 | Calculate the Length of drill | DD Coordinator | |
| | collars required to obtain the | | |
| | Maximum desired WOB. | | |
| Q30 | Obtain Hole enlargement | DD Coordinator/Applications | |
| | equipment specifications for | Engineer | |
| | Max WOB and Torque | | |
| Q31 | Perform Bottom Hole | DD Coordinator/Well Planner | |
| | Assembly force analysis | | |
| | calculations to determine | | |
| | contact points and forces, | | |
| | profile, slope, deflection, shear | | |
| | force and bending moment. | | |
| Q32 | Perform directional tendency | DD Coordinator/Well Planner | |
| | calculations, build/drop/ | | |
| | equilibrium rate/turn | | |
| Q33 | Perform Bit force analysis and | DD Coordinator | |
| | balance with Bottom Hole | | |
| | Assembly forces | | |
| Q34 | Determine if the resulting force | DD Coordinator/Well Planner | |
| | required to deliver directional | | |
| | performance fall within | | |
| | operating limits and adjust | | |
| | Bottom Hole Assembly design | | |
| | as necessary | | |
| Q35 | Obtain bit speed and weight | DD Coordinator/Well | P28, O26 |
| | requirements, mud weight | Planner/ADT | |
| | schedule and proposed | | |
| | trajectory and Perform | | |
| | Harmonic Vibration Analysis | | |
| Q36 | Determine if the resulting | DD Coordinator/Applications | |
| | critical RPM will fall in the | Design Engineer | |
| | proposed operating ranges and | | |
| | adjust Bottom Hole Assembly | | |
| | design if necessary | | |
| R. Task 336: Drillstring Design | | | K10, K33, P30, |
| | | | S4, S23 |
| R1 | Obtain rig hoisting limitations | DD Coordinator/Well Planner | |
| | and derrick load limitations | | |
| R2 | Obtain rig Torque limitations | DD Coordinator/Well Planner | |
| R3 | Obtain the Bit Torque | DD Coordinator/Bit Applications | P25 |
| | requirements | Engineer | |
| R4 | Obtain Wellbore trajectory, | DD Coordinator/Well Planner | K, O26 |
| | wellbore schematic with hole | | |
| | size start and end depths and | | |
| | mud weight schedule | | |
| R5 | Obtain desired Tensional safety | DD Coordinator/Well Planner | |
| | factor or Margin of Overpull | | |
| R6 | Obtain desired Torsional safety | DD Coordinator/Well Planner | |
| | factor | | |
| R7 | Obtain desired safety factor for | DD Coordinator/Well Planner | |
| | pipe collapse | | |
| R8 | Obtain desired safety factor for | DD Coordinator/Well Planner | |
| | pipe burst | | |
| R9 | Obtain Bottom Hole Assembly | DD Coordinator | Q |
| | Specifications and weight in Air | | |
| | of Bottom Hole Assembly | | |
| R10 | For vertical wells calculate | DD Coordinator/Well Planner | |
| | maximum length of pipe using | | |
| | a selected pipe class, grade, size | | |
| | and weight and tension safety | | |
| | factor. | | |
| R11 | Determine if a tapered string is | DD Coordinator/Well Planner | |
| | required and calculate | | |
| | maximum length of pipe using | | |
| | a selected pipe class, grade, size | | |
| | and weight and tension safety | | |
| | factor. | | |
| R13 | Determine if the selected drill | DD Coordinator/Well Planner | |
| | pipe meets the allowable | | |
| | collapse pressure criteria | | |
| R14 | Determine if the selected pipe | DD Coordinator/Well Planner | |
| | meets the allowable internal | | |
| | burst pressure criteria | | |
| R15 | For Deviated wells obtain the | DD Coordinator/Well Planner | A2 |
| | coefficient of friction values for | | |
| | cased and open hole for each | | |
| | hole section | | |
| R16 | For Deviated wells determine | DD Coordinator/Well Planner | |
| | the maximum length of pipe | | |
| | using a selected pipe class, | | |
| | grade, size and weight using | | |
| | trajectory, mud weight and | | |
| | friction factors and safety | | |
| | factor. | | |
| R17 | For Deviated wells calculate the | DD Coordinator/Well Planner | |
| | multiaxial loading for | | |
| | connection stress and fatigue | | |
| | limits | | |
| R18 | For Deviated wells calculate the | DD Coordinator/Well Planner | |
| | torque requirements at TD for | | |
| | each section and determine the | | |
| | torque limits of the selected | | |
| | drill pipe. | | |
| R19 | For Deviated or ERD wells | DD Coordinator/Well Planner | |
| | calculate the makeup torque | | |
| | requirements and assess if high | | |
| | torque connections are required | | |
| R20 | For Deviated wells perform | DD Coordinator/Well Planner | |
| | buckling calculations and | | |
| | determine if a change in | | |
| | drillpipe pipe class, grade, size | | |
| | and weight is required or the | | |
| | placement of HWDP higher in | | |
| | the string, | | |
| S. Task 338: Hydraulics Design | | | K34, P26, P29, |
| | | | P30, Q9, Q15 |
| S1 | Obtain Wellbore trajectory, | DD Coordinator/Well Planner/ | |
| | wellbore schematic with hole | Drilling Fluid Specialist | |
| | size start and end depths, casing | | |
| | sizes | | |
| S2 | Obtain available mud window. | DD Coordinator/Well Planner/ | M1 |
| | | Drilling Fluid Specialist | |
| S3 | Obtain rig surface equipment | DD Coordinator/Well Planner/ | |
| | pressure limitations and pump | Drilling Fluid Specialist | |
| | specifications - Maximum | | |
| | allowable surface pressure. | | |
| S4 | Obtain planned Drillstring | DD Coordinator/Well Planner/ | R |
| | design | Drilling Fluid Specialist | |
| S5 | Obtained planned Mud weight | DD Coordinator/Well Planner/ | O |
| | schedule and rheology | Drilling Fluid Specialist | |
| S6 | Obtained planned bit type/ | DD Coordinator/Well Planner/ | P |
| | Hole Enlargement equipment | Drilling Fluid Specialist/Bit | |
| | specifications | Applications Engineer | |
| S7 | Determine Bit/hole | DD Coordinator/Well Planner/ | P26 |
| | enlargement flow optimization | Drilling Fluid Specialist/Bit | |
| | requirements for velocity, HSI | Applications Engineer | |
| | or HHP. | | |
| S8 | Determine if a motor is planned | DD Coordinator/Well Planner | Q14 |
| | and obtain flow rate | | |
| | requirements and bit pressure | | |
| | drop requirements for bearing | | |
| | lubrication | | |
| S9 | Determine method of activation | DD Coordinator/Well Planner/ | S9 |
| | of any hole enlargement | Drilling Fluid Specialist/Bit | |
| | equipment and plan for | Applications Engineer | |
| | hydraulic activation if required | | |
| S10 | Determine MWD telemetry | M/LWD Coordinator | Q18 |
| | system flow rate and pressure | | |
| | drop requirements | | |
| S11 | Determine MWD downlink | M/LWD Coordinator/DD | Q18 |
| | system flow rate and pressure | Coordinator | |
| | drop requirements | | |
| S12 | Obtain MWD mass flow rate | M/LWD Coordinator/DD | Q23 |
| | limitations | Coordinator | |
| S13 | Determine most applicable | Drilling Fluid Specialist | |
| | rheology model for mud fluid | | |
| | type. (Herschel Bulkley, | | |
| | Bingham, Power law, etc.) | | |
| S14 | Determine ROP/Flow limits | DD Coordinator/Well Planner/ | |
| | for Hole cleaning | Drilling Fluid Specialist | |
| S15 | Calculate system pressure | DD Coordinator/Well Planner/ | |
| | losses, bit TFA and maximum | Drilling Fluid Specialist | |
| | flow rate | | |
| S16 | Calculate maximum ECD at the | DD Coordinator/Well Planner/ | |
| | bottom hole, shoe and zones of | Drilling Fluid Specialist | |
| | low fracture gradient | | |
| S17 | For ERD wells add safety factor | DD Coordinator/Well Planner/ | |
| | for rotational effect increasing | Drilling Fluid Specialist | |
| | ECD in smaller hole sizes | | |
| S18 | Calculate annular velocities and | DD Coordinator/Well Planner/ | |
| | ensure laminar flow | Drilling Fluid Specialist | |
| S19 | Estimate cutting slip velocity | DD Coordinator/Well Planner/ | |
| | based on expected cuttings | Drilling Fluid Specialist | |
| | density and size | | |
| S20 | Estimate cuttings bed heights | DD Coordinator/Well Planner/ | |
| | and locations based on expected | Drilling Fluid Specialist | |
| | flow rates | | |
| S21 | Determine safety margin for | DD Coordinator/Well Planner/ | |
| | swab and surge pressures | Drilling Fluid Specialist | |
| S22 | Calculate swab/surge | DD Coordinator/Well Planner/ | |
| | pressures and maximum | Drilling Fluid Specialist | |
| | tripping speeds compared to | | |
| | wellbore pressure boundaries | | |
| S23 | If required Determine if | DD Coordinator/Well Planner | R |
| | changes to drillstring design | | |
| | will allow higher flow rates to | | |
| | improve hole cleaning or reduce | | |
| | maximum surface pressures | | |
| S24 | If required Determine if | DD Coordinator/Well Planner | Q |
| | changes to Bottom Hole | | |
| | Assembly design will allow | | |
| | higher flow rates to improve | | |
| | hole cleaning or reduce | | |
| | maximum surface pressures | | |
| S25 | If required Determine if motor | DD Coordinator/Well Planner | Q13 |
| | requires a jetted rotor design to | | |
| | allow higher flow rates to | | |
| | improve hole cleaning or reduce | | |
| | maximum surface pressures | | |
| S26 | Determine if changes to Bit | DD Coordinator/Bit Applications | P29 |
| | Nozzle selection will reduce | Engineer | |
| | maximum surface pressures | | |
| T. Task 340: Drill Well | | | |
| T1 | Drill | | |

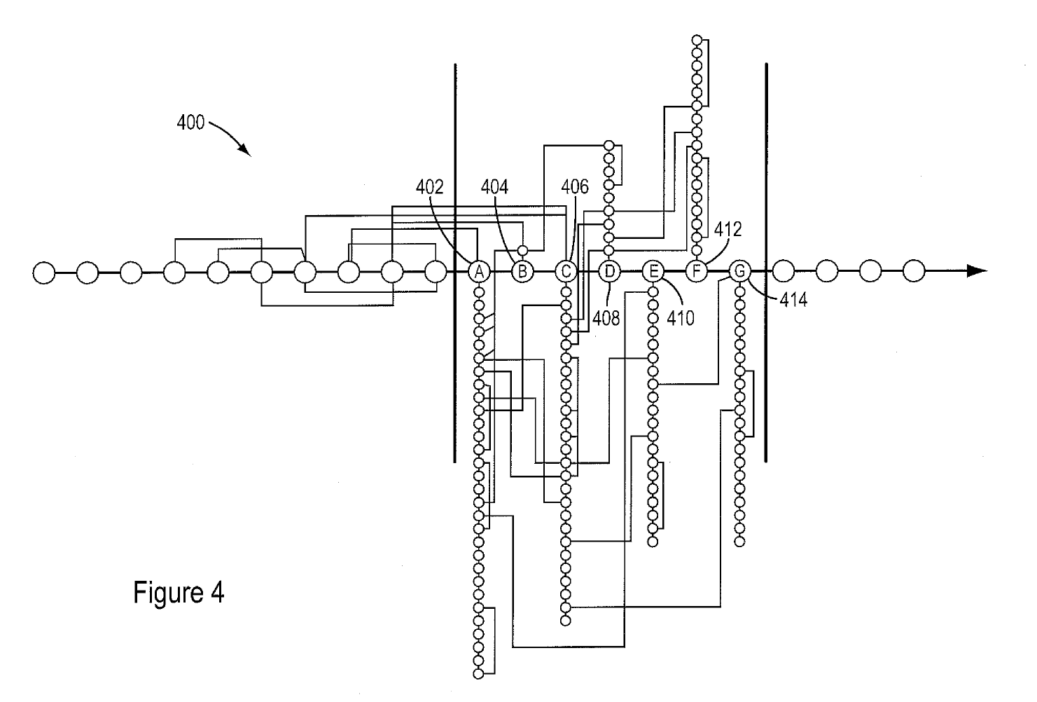

FIG. 4 illustrates another example workflow 400 that can be optimized according to some embodiments of the present invention. As shown in FIG. 4, workflow 400 includes task 402 (Well Trajectory Design), task 404 (Wellbore Integrity Analysis), task 406 (Drilling Fluid Design and Management), task 408 (Bit/Reamer/Hole Opener Design), task 410 (Bottom Hole Assembly Design), task 412 (Drillstring Design) and task 414 (Hydraulics Management). Workflow 400 represents a simplified drilling optimization workflow according to some embodiments of the present invention, utilized for examples. As shown in FIG. 4, task 402 includes subtasks. In accordance with embodiments of the present invention, tasks 402-414 are linked as illustrated in FIG. 4 and then optimized.

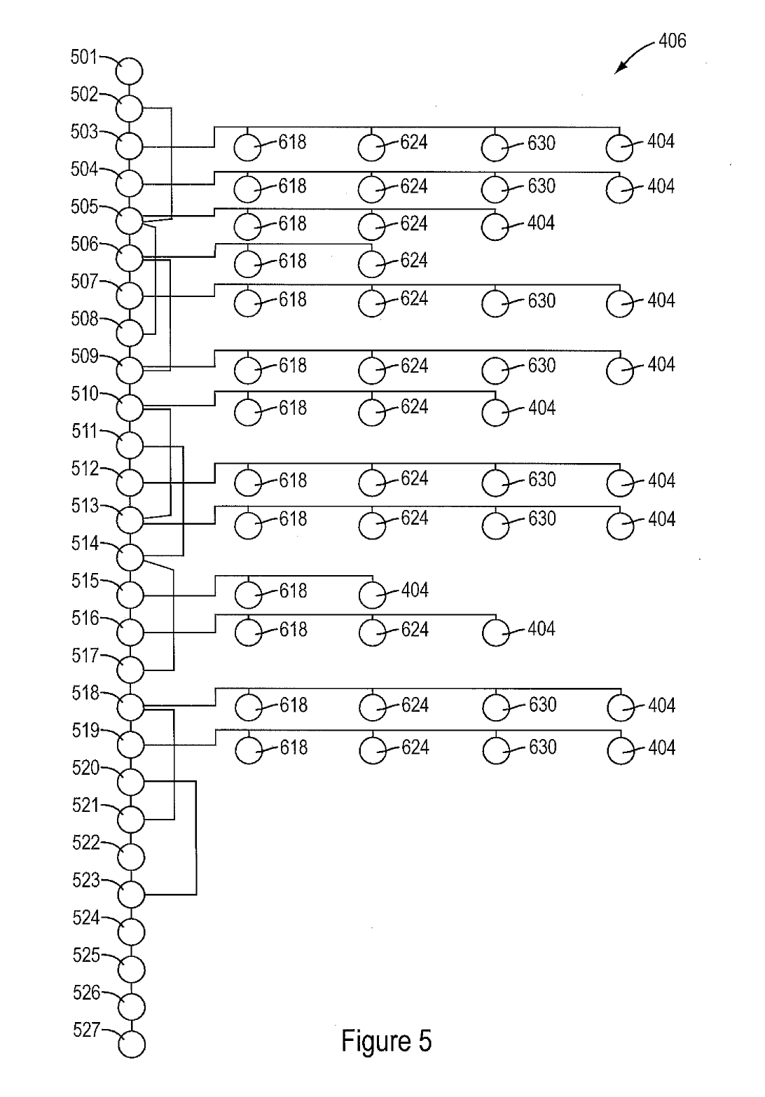

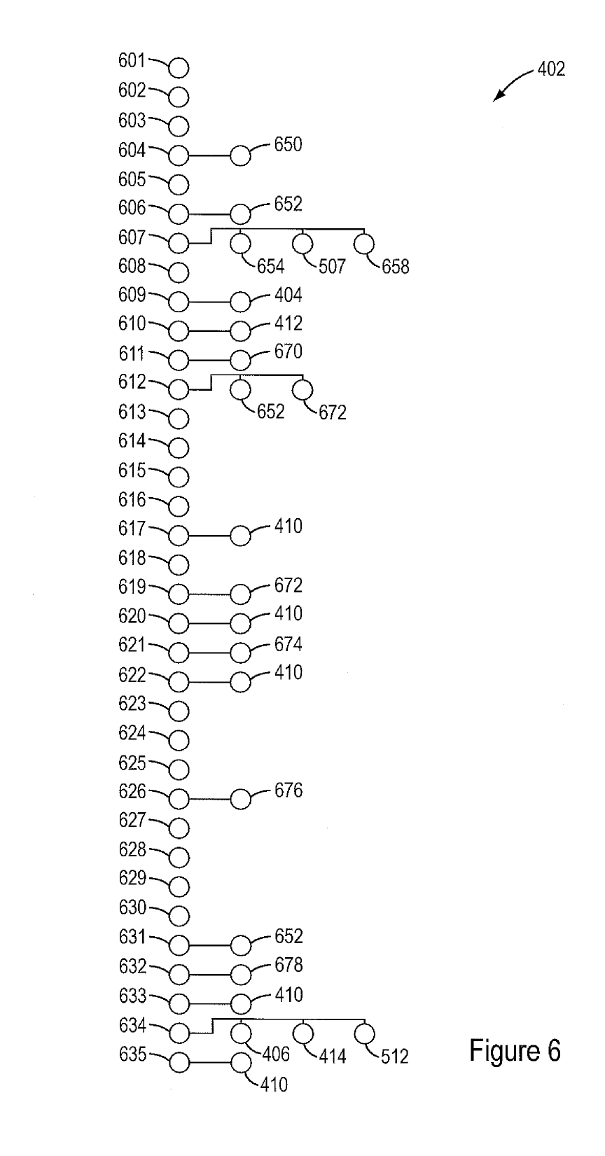

FIG. 5 illustrates an example of task 406 of workflow 400. FIG. 6 illustrates an example of task 402 of workflow 400. As shown in FIG. 5, task 406 (Drilling Fluids Design) can include subtasks 501-527 and may include inputs from other individual workflows such as task 402 (Well Trajectory Design) and task 404 (Wellbore Integrity Analysis). Table 2 defines each of subtasks 501 through 527 of task 406. Table 3 defines each of subtasks 601 through 627 of task 402 (Well Trajectory Design).

TABLE 2

| Subtask | Description | Performance Responsibility |
|---|---|---|
| 501 | Obtain reservoir requirements, | Drilling Fluid Specialist/Well |
| | geological objectives, | Planner/Customer |
| | reservoir description | |
| | (lithology column for well | |
| | path), fault formation, | |
| | temperature profile, casing | |
| | design, PP/FG plots as | |
| | provided by the customer | |
| 502 | Determine if the reservoir call | Drilling Fluid Specialist/Well |
| | for a drill-in fluid or other | Planner/Customer/Drilling |
| | specialized system | Fluid Technical Group |
| 503 | Determine the appropriate | Drilling Fluid Specialist/Well |
| | fluid types and technologies | Planner/Customer/Drilling |
| | for the specific well/project | Fluid Technical Group |
| | and sections/intervals | |
| 504 | Determine the completion | Drilling Fluid Specialist/Well |
| | fluid requirements | Planner/Customer/Drilling |
| | | Fluid Technical |
| | | Group/Completion Fluid |
| | | Specialist |
| 505 | Determine the local | Drilling Fluid |
| | environment regulations | Specialist/Customer/Well |
| | | Planner/Health, Safety and |
| | | Environment Specialist |
| 506 | Determine what the drilling | Drilling Fluid Specialist/BSS |
| | waste profile associated with | TP/Customer |
| | the project is | |
| 507 | Determine if there are special | Drilling Fluid Specialist/Well |
| | challenges of this well (e.g., | Planner/Customer |
| | deepwater, HPHT, logistical | |
| | issues, depleted zones, | |
| | formation damage, etc) that | |
| | affects the fluid design. | |
| 508 | Determine need for | Drilling Fluid |
| | customized solutions/new | Specialist/Drilling Fluid |
| | technology | Technical Group |
| 509 | Determine if this is a critical | Drilling Fluid |
| | first well | Specialist/Drilling Fluid |
| | | Technical Group |
| 510 | Determine if the well call for | Drilling Fluid |
| | specialized lab equipment | Specialist/Customer |
| 511 | Determine if wellbore stability | Drilling Fluid |
| | modeling is required | Specialist/Customer |
| 512 | Determine if there are any | Drilling Fluid |
| | challenges with regard to the | Specialist/Customer |
| | hole cleaning, angle of well | |
| | that requires modification to | |
| | the drilling fluid | |
| 513 | Evaluate need for lab testing | Drilling Fluid |
| | to determine what/if the mud | Specialist/Drilling Fluid |
| | system is suited for drilling | Technical Group |
| | under the planned well | |
| | conditions | |
| 514 | Perform lab tests to determine | Drilling Fluid |
| | composition of LCM pills or | Specialist/Drilling Fluid |
| | Wellset treatment if required. | Technical Group |
| 515 | Obtain data from offset wells | Drilling Fluid Specialist |
| | or wells that have been drilled | |
| | under similar conditions to get | |
| | an understanding of what | |
| | could be expected for the next | |
| | well to be drilled. | |
| 516 | Design LCM decision trees or | Drilling Fluid |
| | matrix based on formations to | Specialist/Drilling Fluid |
| | be drilled. | Technical Group |
| 517 | Determine stuck pipe | Drilling Fluid |
| | procedures | Specialist/Drilling Fluid |
| | | Technical Group |
| 518 | Create a Basis of Design | Drilling Fluid Specialist |
| | (BOD) | |
| 519 | Create a Total Fluid | Drilling Fluid Specialist |
| | Management (TFM) | |
| 520 | Create Drilling Fluid Program | Drilling Fluid |
| | and Completion Fluid | Specialist/Completion Fluid |
| | Program if required | Specialist |
| 521 | Review together with | Drilling Fluid Specialist |
| | customer and get customers | |
| | approval | |
| 522 | Perform mud formulation | |
| | based on given formation | |
| | pressure/anticipated hole | |
| | problems | |
| 523 | Select mud type/properties | |
| | for each hole section | |
| 524 | Specify mud properties like | |
| | mud wt/yield point/gel | |
| | strength/pH/MBT/ | |
| | Chloride/Solid content/ | |
| | Filtrate quantity/filtrate | |
| | analysis | |
| 525 | Run hydraulic DFG for each | |
| | hole section and estimate the | |
| | proper ROP/gpm to minimize | |
| | cutting load in the annulus | |
| 526 | Adjust ROP while drilling to | |
| | minimize cutting load | |
| 527 | Determine mud wt schedule | |
| | for each hole section. | |

TABLE 3

| Subtask | Description | Performance Responsibility |
|---|---|---|
| 601 | Obtain Customer Reference | DD Coordinator/Well |
| | Documentation. Tool | Planner/Survey Manager |
| | Instrument Performance | |
| | Model files, anti-collision | |
| | practices, | |
| | drilling and surveying | |
| | practices | |
| 602 | Determine Single/Multi well | DD Coordinator/Well |
| | path design | Planner/Survey Manager |
| 603 | Determine Geological Target | Obtained from customer by |
| | (s) | DD Coordinator, Well Planner |
| | | updates plans |
| 604 | Determine Drillers Target(s) | Obtained from customer by |
| | | DD Coordinator, Well Planner |
| | | updates plans |
| 605 | Determine the boundaries of | Customer/Well Planner |
| | any lease line or block | |
| 606 | Obtain offset well survey | Obtained by DD Coordinator, |
| | information and QA type of | Well Planner updates plans |
| | surveys to determine correct | |
| | Instrument Performance | |
| | Model. | |
| 607 | Determine any zones to avoid | Customer/DD |
| | penetrating, (Injection/ | Coordinator/Well Planner |
| | production/cuttings injection/ | |
| | subsidence). | |
| 608 | Determine inclination | Customer/DD |
| | limitations for Top hole | Coordinator/Well Planner |
| | section, riserless section or | |
| | entire wellbore. | |
| 609 | Determine inclination and | Customer/DD |
| | azimuth sensitivities for | Coordinator/Well Planner |
| | borehole stability | |
| 610 | Determine inclination and | Customer/DD |
| | azimuth sensitivities for | Coordinator/Well Planner |
| | Torque and Drag limitations. | |
| 611 | Determine formation | Customer/DD |
| | tendencies for build/drop/ | Coordinator/Well Planner |
| | turn rates. | |
| 612 | Identify formations that are | DD Coordinator/Well Planner |
| | difficult/impossible to steer | |
| | in or have ‘natural’ formation | |
| | tendencies | |
| 613 | Plan Well Path aiming to | DD Coordinator/Well Planner |
| | continually diverge from all | |
| | existing wells from the kick | |
| | off point. | |
| 614 | Plan to minimize Doglegs in | DD Coordinator/Well Planner |
| | top hole sections. | |
| 615 | Perform Anti collision | DD Coordinator/Well Planner |
| | Analysis, review high risk | |
| | wells and report to the | |
| | customer. | |
| 616 | Determine if gyro or steering | DD Coordinator/Well Planner |
| | tools are required because of | |
| | magnetic interference. | |
| 617 | Establish the effect of TVD | DD Coordinator/Well |
| | uncertainties especially when | Planner/Survey Manager |
| | planning horizontal The effect | |
| | of TVD uncertainly, due to | |
| | both geology and survey error | |
| | should be accounted for in the | |
| | plan so that well can still be | |
| | landed within the dogleg | |
| | capability of the equipment. | |
| 618 | Establish the effect of drilling | DD Coordinator/Well |
| | close to magnetic east west | Planner/Survey Manager |
| | and close to horizontal, based | |
| | on the latitude of the well. | |
| 619 | Determine length of Rat hole | Customer/DD |
| | required at TD for logging | Coordinator/Well |
| | tools | Planner/Survey Manager |
| 620 | Determine differential sticking | Customer |
| | risk. Compensate within | |
| | wellplan for build and drop | |
| | above and below the risk zone | |
| | as sliding may result in stuck | |
| | pipe. | |
| 621 | Perform Anti collision | Customer/DD |
| | Analysis, review high risk | Coordinator/Well Planner |
| | wells and report to the | |
| | customer. | |
| 622 | Consider options for collision | DD Coordinator/Well Planner |
| | avoidance should the | |
| | directional plan not be | |
| | achieved | |
| 623 | Determine if sidetracks are | Customer/DD |
| | Planned | Coordinator/Well Planner |
| 624 | When sidetracking an existing | DD Coordinator/Well Planner |
| | wellbore review QA | |
| | information of main bore and | |
| | generate definitive survey | |
| | listing | |
| 625 | When sidetracking an existing | DD Coordinator/Customer |
| | wellbore determine if the | |
| | location of the KOP is in open | |
| | hole or inside casing and | |
| | obtain hole diameter | |
| 626 | When sidetracking an existing | DD Coordinator/Customer |
| | wellbore determine the top of | |
| | the cement in open hole or | |
| | behind casing. | |
| 627 | When sidetracking an existing | DD Coordinator/Customer |
| | wellbore determine the Kick | |
| | off method, (open hole, | |
| | cement plug, whipstock) | |
| 628 | When Sidetracking an existing | DD Coordinator/Well |
| | wellbore produce Ladder plots | Planner/Survey Manager |
| | or travelling cylinder and | |
| | clearance listings in sufficient | |
| | detail to show the planned | |
| | divergence from the parent | |
| | well, casing stumps and the | |
| | zones of magnetic | |
| | interference. | |
| 629 | When sidetracking determine | DD Coordinator/Well |
| | the requirement for gyro | Planner/Survey Manager |
| | singles shots, gyro multishots, | |
| | or gyro MWD over the zone | |
| | of magnetic interference Any | |
| | risk of collision shall be | |
| | documented | |
| 630 | When Sidetracking Perform | DD Coordinator/survey |
| | Anti collision Analysis, review | management |
| | high risk wells and report to | |
| | the customer. | |
| 631 | QA check proposed well | DD Coordinator |
| | design with offset well | |
| | performance | |
| 632 | Review surface location | Customer/DD Coordinator |
| | position to determine if well | |
| | path design can be improved | |
| | by modifying it. | |
| 633 | Review Torque and Drag for | Customer/DD Coordinator |
| | Drillstring and Casing to | |
| | determine if well path design | |
| | can be improved by | |
| | modifying it. | |
| 634 | Review Fluid Design, | Customer/DD Coordinator |
| | Hydraulics and hole cleaning | |
| | to determine if well path | |
| | design can be improved by | |
| | modifying it. | |
| 635 | Review Bottom Hole | Customer/DD Coordinator |
| | Assembly Designs to | |
| | determine if directional | |
| | performance can be optimized | |
| | by modifying the well | |
| | path design | |

FIG. 5 further shows some of the links to other tasks and subtasks that are utilized in subtasks 501-527 of task 406 (Drilling Fluids Design). As is shown in FIG. 5, subtasks 503, 504, 507, 509, 512, 513, 518, and 519 of task 406 are each linked to subtasks 618, 624, and 630 of task 402 (Well Trajectory Design) and to task 404 (Wellbore Integrity Analysis). Subtask 505, 510, and 516 are each linked to subtasks 618 and 624 of task 402 and to task 404. Subtasks 506 and 515 of task 406 are each lined to subtask 618 of task 402 and to task 404.

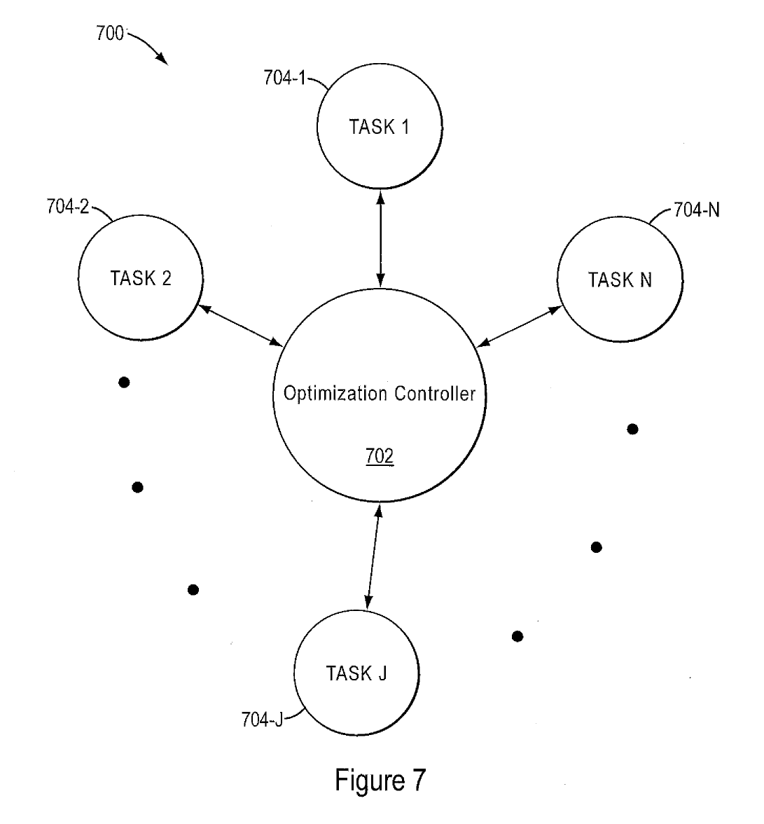

FIG. 6 further illustrates some links to other tasks and subtasks that are utilized in task 402 (Well Trajectory Design). As shown in FIG. 7, subtask 604 is linked to subtask 650, which can be the fourth subtask in task 412 (Drillstring Design): Obtain Wellbore trajectory, wellbore schematic with hole size start and end depths and mud weight schedule. Subtask 606 is linked to subtask 652, which is a subtask of an “Obtain Target Location” task: Carry out a database search for offset wells already drilled and review relevant well designs, plots, logs and end of well reports. Subtask 607 is linked to task 654 (Determine Reservoir Type, Extent of Reservoir and Required Exposure), subtask 507 of task 406 and subtask 658 of task 410 (Bottom Hole Assembly Design): Obtain Build/Drop/Equilibrium Rate Requirements/Limitations and target tolerances. Subtask 609 is linked to task 404 (Wellbore Integrity Analysis). Subtask 610 is linked to task 412 (Drillstring Design). Subtask 611 is linked to subtask 670 of task 410: Obtain formation tendencies. Subtask 612 is linked to subtask 652 and subtask 672 of task 404 (Perform Hazard identification—salt, rubble zones, faults, fractured zones, vuggy or karst formations). Subtask 617 is linked to task 410. Subtask 619 is linked to subtask 672. Subtask 620 is linked to task 410. Subtask 621 is linked to subtask 674 of task 410 (Obtain Anti-collision program). Subtask 622 is linked to task 410. Subtask 626 is linked to task 676 (Cement Design). Subtask 631 is linked to subtask 652. Subtask 632 is linked to task 678 (Obtain Surface Location). Subtask 633 is linked to task 410. Subtask 634 is linked to task 406 (Drilling Fluids Design), task 414 (Hydraulics design), and subtask 512 of task 406. Subtask 635 is linked to task 410.

Similar subtask definitions and linkages can be provided for each of tasks 402 through 414. Therefore, in optimizing the drilling environment utilizing workflow 400 as illustrated in FIG. 4, once task 414 is completed the optimization routine returns to perform tasks 402-414 again. The process continues until it converges onto an optimum drilling design.

FIG. 7 illustrates a system 700 for optimizing N tasks in a workflow environment. As shown in FIG. 7, optimization controller 702 provides the framework for performing each of the tasks in order. Once task 704-1, the resulting design can be uploaded to optimization controller 702. Optimization controller 702 can then enable performance of task 704-2. Once task 704-2 is completed and the resulting design parameters uploaded to optimization controller 702, then optimization controller proceeds to enable the next task. Once the last task, task 704-N, is performed and the resulting design is uploaded to optimization controller 702, then optimization controller 702 can begin again to enable task 704-1. In doing so, optimization controller 702 can upload design parameters that result from the linkages formed between task 704-1 and the other tasks 704-2 through 704-N as discussed above. Similarly, optimization controller 702 continues to cycle through tasks 704-1 through 704-N until convergence is achieved. The optimization controller can perform all of the tasks 704-1 through 704-N sequentially as described above, or in some embodiments has the capability to detect only the tasks 704-1 through 704-N that need to be performed based on changes in the state of the tasks 704-1 through 704-N within the workflow so that convergence is achieved more rapidly.

As examples, tasks 704-1 through 704-N can correspond to tasks 322, 324, 330, 332, 334, 336, and 338 illustrated in FIG. 3 and defined in Table 1. Similarly, tasks 704-1 through 704-N can correspond to tasks 402-414 illustrated in FIGS. 4-6 and Tables 1 and 2.

As discussed above, optimization controller 702 can be a central computer. Tasks 704-1 through 704-N or groupings of tasks can be performed utilizing peripheral computers controlled by the particular group with responsibility for performing that task or grouping of tasks and the results uploaded to optimization controller 702. Alternatively, all of tasks 704-1 through 704-N or groupings of tasks can be performed utilizing the central computer of optimization controller 702, which can be linked through a network with peripheral computers. In that case, all of the design parameters and results remain on optimization controller 702. Alternatively, all of tasks 704-1 through 704-N or groupings of tasks can be performed utilizing the central computer of optimization controller 702 that controls the peripheral computers to which the optimization controller 702 is linked through a network. In that case, all of the design parameters and results of the task or groupings of tasks performed on the peripheral computers remain on the peripheral computers and the results of the overall analysis are retained on the optimization controller 702.

The above detailed description is provided to illustrate specific embodiments of the present invention and is not intended to be limiting. Numerous variations and modifications within the scope of the present invention are possible. The present invention is set forth in the following claims.

1. A computer-implemented method of optimizing a well drilling design, comprising:
identifying a plurality of tasks to be optimized, the plurality of tasks being in a well drilling design workflow for the well drilling design;
identifying links to other tasks and subtasks in the well drilling design workflow; and
repeatedly performing tasks in the plurality of tasks until the well drilling design is optimized according to optimization parameters.

2. The computer-implemented method of claim 1, wherein the plurality of tasks are chosen from a set of tasks consisting of Well Trajectory, Wellbore Integrity Analysis, Drilling Fluids Design, Drill Bit and Hole Opener Design, Bottom Hole Assembly Design, Drillstring Design, and Hydraulics Management.

3. The computer-implemented method of claim 1, wherein identifying links comprises: determining subtasks associated with each of the plurality of tasks; determining parameters that are affected by results of performing other tasks or subtasks;
and
defining links between the tasks or subtasks based on the affected parameters.

4. A drilling plan optimizer system, comprising: an optimization controller; and
a plurality of peripheral computers coupled to the optimization controller, each of the plurality of peripheral computers corresponding to one of a plurality of drilling plan tasks or subtasks to be optimized, the plurality of tasks or subtasks being in a well design workflow,
wherein the optimization controller enables each of the plurality of tasks or subtasks and provides linked designs and parameters to others of the plurality of tasks or subtasks.

5. The computer-implemented method of claim 1, wherein the optimization parameters are defined based upon one or more of a rate of penetration, lessening of non-production time or production targets.

6. The computer-implemented method of claim 1, further comprising:
detecting changes in a state of the tasks; and
determining the tasks that need to be further performed based upon the changes in the state of the tasks.

7. A system comprising processing circuitry to implement any of the methods in claim 1-3, 5 or 6.

8. A computer program product comprising instructions which, when executed by at least one processor, causes the processor to perform any of the methods in claim 1-3, 5 or 6.

9. A computer-implemented method of optimizing a well drilling design, comprising:
determining an optimization goal;
identifying a plurality of tasks to be optimized, the plurality of tasks being in a well drilling design workflow for the well drilling design;
for a plurality of the tasks, identifying subtasks needed for the implementation of the task;
identifying links between to other tasks and subtasks in the well drilling design workflow; and
performing optimization of the tasks and subtasks until the optimization goal has been satisfied.

10. The computer-implemented method of claim 9, wherein determining an optimization goal comprises selecting from a plurality of optimization criteria.

11. The computer-implemented method of claim 9, wherein inputs and outputs for each task and subtask are identified.

12. The computer-implemented method of claim 11, further comprising identifying common inputs and outputs for between tasks and subtasks, wherein the identified links are based on the common inputs and outputs between tasks and subtasks.

13. The computer-implemented method of claim 9, wherein technical groups for performing each task and subtask are identified.

14. The computer-implemented method of claim 13, further comprising identifying common technical groups for tasks and subtasks, wherein the identified links are based on the common technical groups for tasks and subtasks.

15. The computer-implemented method of claim 14, wherein technical groups for performing each task and subtask are identified, and further comprising identifying common technical groups for tasks and subtasks, wherein the identified links are based on the common technical groups for tasks and subtasks.

16. The computer-implemented method of claim 15, wherein the tasks include reservoir analysis, drilling, casing and cementing, completion and production.

17. The computer-implemented method of claim 16, wherein performing optimization comprises repeatedly performing tasks and subtasks in the plurality of tasks and subtasks utilizing the links until the plurality of tasks and subtasks in the well drilling design is optimized according to optimization parameters.
